(19) United States
(12) Patent Application Publication
(10) Pub. No.: US 2014/0021199 A1
(43) Pub. Date: Jan. 23, 2014

(54) HANDLE WITH A HEAT SINK

(71) Applicants: Olanrewaju Ari Adeniyi, West Palm Beach, FL (US); Craig Magee Nold, Louisville, KY (US)

(72) Inventors: Olanrewaju Ari Adeniyi, West Palm Beach, FL (US); Craig Magee Nold, Louisville, KY (US)

(21) Appl. No.: 13/551,948

(22) Filed: Jul. 18, 2012

(51) Int. Cl. H05B 6/64; B25G 1/10

(52) U.S. Cl. 219/757; 16/431

(57) ABSTRACT

A handle is disclosed. The handle includes a casing, which includes an outside surface and an inside surface. The handle further includes a pliable heat sink disposed on the inside surface of the handle casing. A microwave oven incorporating such a handle is also disclosed.

### BACKGROUND OF THE INVENTION

The subject matter described herein relates generally to a handle, and more specifically to a microwave oven handle with a heat sink that more effectively lowers the surface temperature of the handle.

In some appliances, a handle is used to open and close a door that allows a user access to the interior of the appliances. At least some of these appliances are designed to be installed above a source of heat, such as a range, cooktop, grill. When the heat source under the appliance is activated, the heat increases the temperature of the exterior surface of the appliance handle. Depending on the heating capacity of the heat source, the construction of the appliance handle, and the time the heat source is active, the exterior temperature of the appliance handle may become elevated to a temperature at which it becomes uncomfortable for a user to touch. Preferably, the temperature of the surface of any such handle should remain below a pre-determined temperature, such as 75 degrees Fahrenheit, after a certain period of time, such as 30 minutes, after the heat source below being active.

Known handles for such appliances typically are made of plastic or metal and may also contain an additional metal core therein. In known handles without a metal core, the low thermal mass of the hollow handle will heat up quickly and may reach a temperature at which it becomes uncomfortable for a user to touch. Handles with metal cores heat up more slowly given the larger thermal mass that must be heated before the exterior temperature of the handle reaches a temperature at which it becomes uncomfortable for a user to touch. However, these handles with metal cores have poor thermal conductivity between the exterior surface of the handle and the respective metal core. Furthermore, the addition of a metal core to an appliance handle would increase the overall cost of the handle.

In addition, surface heat units of ranges and cooktops are increasingly being manufactured with higher heat output which increases the temperature of handles of appliances installed above them. Thus, it would be desirable to have an appliance handle that more efficiently reduces the surface temperature of the handle.

### BRIEF DESCRIPTION OF THE INVENTION

As described herein, the exemplary embodiments of the present invention overcome one or more disadvantages known in the art.

In one aspect, a handle is provided that comprises a casing. The casing comprises an outside surface and an inside surface. The handle further comprises a pliable heat sink disposed on the inside surface of the casing.

In another aspect, a microwave oven is provided. The microwave oven comprises a door and a handle attached to the door. The handle comprises a casing. The casing comprises an outside surface and an inside surface. The handle further comprises a pliable heat sink disposed on the inside surface of the casing.

These and other aspects and advantages of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. Moreover, the drawings are not necessarily drawn to scale and, unless otherwise indicated, they are merely intended to conceptually illustrate the structures and procedures described herein.

### BRIEF DESCRIPTION OF THE DRAWINGS

In the drawings:

FIG. 1 is view of an appliance with a handle according to an embodiment, which is mounted over a heat source;

FIG. 2 is a perspective view of the appliance of FIG. 1;

FIG. 3 is a perspective view of the handle of the appliance of FIG. 1;

FIGS. 4 through 6 are exploded, perspective views of different embodiments of the handles;

FIGS. 7 and 8 are schematic, cross sectional views of the handles of FIGS. 4 and 6, respectively.

### DETAILED DESCRIPTION OF THE PREFERRED EMBODIMENTS OF THE INVENTION

As used herein, the term “appliance” is intended to be representative of any device that is commonly used to perform domestic tasks including, but not limited to, cooking, cleaning, and food storage.

As used herein, the term “pliable heat sink” is intended to be representative of any compound that can be used to store, radiate, or transfer thermal energy, and can easily conform its shape to curved and/or complex surfaces. Examples of pliable heat sinks include, but are not limited to, thermally conductive pastes, thermally conductive pads, thermally conductive grease, and thermally conductive adhesives. More specifically, embodiments described herein may use a number of commercial products as pliable heat sinks Suitable thermally conductive pastes are marketed, for example, by Cooler Master, Ltd. as “Ice Fusion” thermal compound, by Artic Silver, Inc. as “Artic Silver® 5”, and by Timtronics as “Blue Ice.” Suitable thermal putties are marketed by Timtronics as “TIM-PUTTY 418HTC.” Suitable thermally conductive pads are marketed by Timtronics as “TIM-GAP 1106” and “TIM-GAP ULTRA SOFT.” Such pliable heat sinks are configured to have low thermal resistance, high thermal conductivity, and/or high thermal density.

Pliable heat sinks are typically comprised of silver metal and a binding agent such as silicone. As such, they generally have significantly higher thermal conductivity than that of the casing of a handle which is typically made from a polymeric material. It is the high thermal conductivity of these materials that allow embodiments of the handles described herein to reduce the surface temperature of the handle so significantly in comparison to handles currently available that do not have such pliable heat sinks.

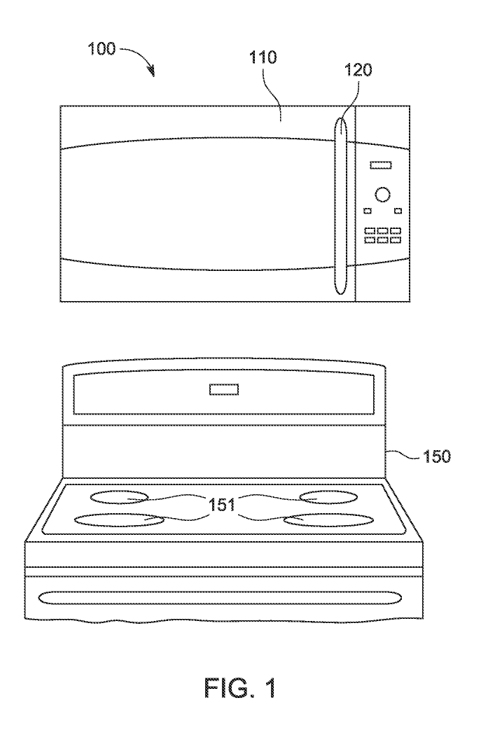

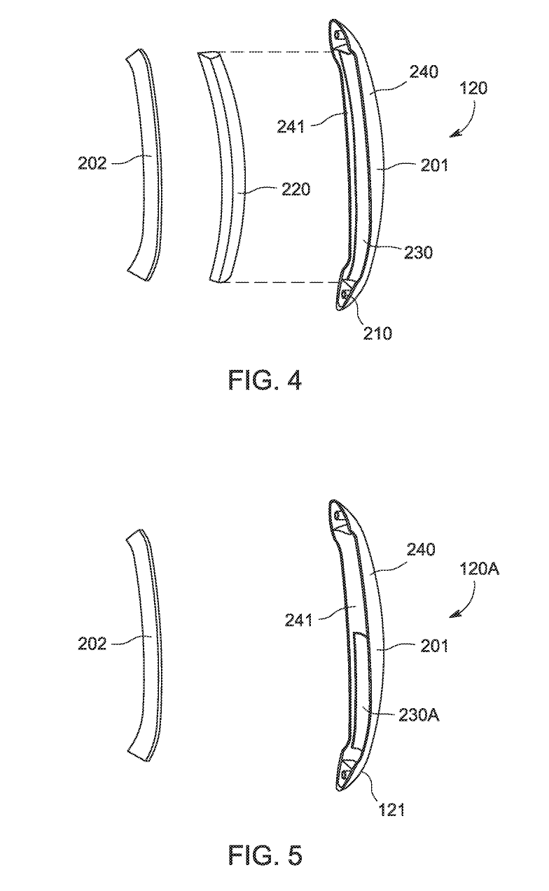

FIG. 1 shows an appliance such as a microwave oven 100 mounted above a range 150 that has a plurality of surface heating units 151. When a surface heating unit 151 is activated, heat rises from the surface heating unit 151 upward the microwave oven 100. The microwave oven 100 has a door 110 that allows a user access to the interior of the microwave oven 100. A handle 120 is mounted to the door 110 to allow the user to open and close the door 110 by hand. Once the surface heating unit 151 is activated, heat begins to increase the temperature of the outside surface 240 (the outside surface 240 is shown in FIGS. 4-6) of the handle 120.

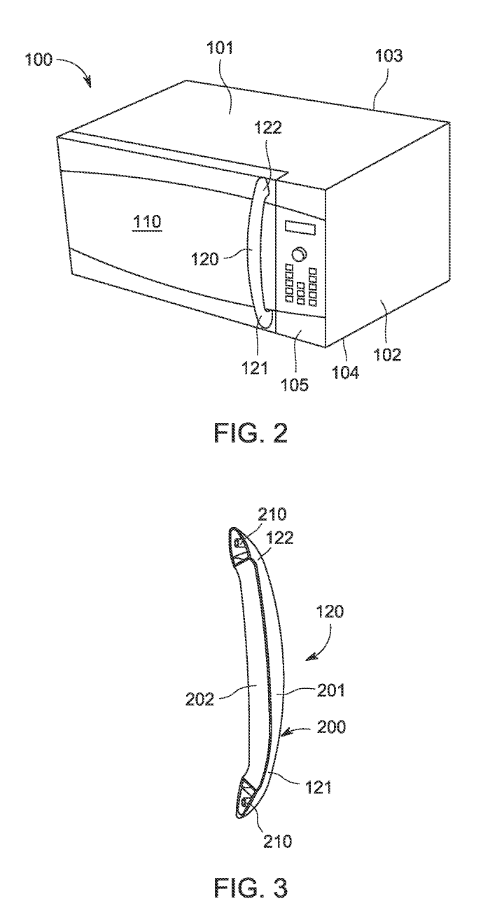

FIG. 2 shows a perspective view of the microwave oven 100. The microwave oven 100 has a top 101, two sides 102, a back 103, a bottom 104, and a front 105. The front 105 of the microwave oven 100 has a door 110 that allows a user access to the interior of the microwave oven 100. A handle 120 is mounted to the door 110 to allow the user to open and close the door 110 by hand. In the embodiment shown, the handle 120 is oriented substantially vertically such that the bottom 121 of the handle 120 is oriented closer to a surface heating unit below than the top 122 of the handle 120. One skilled in the art would recognize, however, that although the handle 120 depicted in FIG. 2 shows the handle 120 mounted substantially vertically, a handle to the microwave oven 100 may be mounted in any orientation on the door 110 of the microwave oven 100.

FIG. 3 shows a perspective view of the handle 120 from FIGS. 1 and 2 dismounted from the door 110 of the microwave oven 100. The handle 120 is oriented such that the bottom 121 of the handle 120 would, in its mounted position, be oriented closer to any source of heat as compared to the top 122 of the handle 120. The exterior shape of the handle 120 is defined by a casing 200 comprised of an outside casing 201 which faces the user when the handle 120 is in its mounted position attached to the microwave oven 100, and an inside casing 202 which faces the door 110 of the microwave oven 100 when the handle 120 is in its mounted position. The casing 200 may be constructed out of any suitable material such as a polymeric material, metal, fibre reinforced plastic, or any combination thereof. Methods for manufacturing the casing 200 through conventional means are well known to one skilled in the art and therefore are not discussed in detail here. The handle 120 is mounted to the door 110 using screws (not shown) that are designed to be received by screw anchors 210. It should be appreciated that screws are only one method of attaching the handle 120 to the door 110 of the microwave oven 100 and any other fastening system such as an adhesive or clips would work as well.

FIG. 4 shows an exploded, perspective view of one embodiment of the handle 120. In this view, the inside casing 202 is removed from the outside casing 201 to show the outside surface 240, which is the surface of the outside casing 201 that faces the outside environment, and the inside surface 241, which is the surface of the outside casing 201 that faces the interior of the handle 120. In this embodiment, a pliable heat sink 230 is disposed on the inside surface 241 of the outside casing 201. Preferably, the pliable heat sink 230 may be disposed on the inside surface of the inside casing 202 as well. In this embodiment, the pliable heat sink 230 is in the nature of a thermally conductive paste. Although FIG. 4 illustrates a pliable heat sink 230 distributed evenly along almost the entire length of the inside surface 241, the pliable heat sink 230 could also be located only in one portion or portions of the length of the inside surface 241, such as at the bottom 121 (FIG. 3) to concentrate the ability of the pliable heat sink 230 to transfer thermal energy to a metal core 220 at the location where the most amount of thermal energy is directed due to its relative proximity to the range 150. The metal core 220 is inserted into the interior of the handle 120 before the inside casing 202 is attached to the outside casing 201 and the handle 120 mounted to the door 110 of the microwave oven 100. In one embodiment, it is possible to keep the surface temperature of the handle to 50 degrees Fahrenheit after 30 minutes of an exemplary heat source being active, well below the target temperature of 75 degrees Fahrenheit where it becomes uncomfortable for a user to touch, and well below the temperature of 72 degrees Fahrenheit at which current production handles are able to achieve under the same testing conditions.

As best illustrated in FIG. 7 (a schematic, cross sectional view of the embodiment shown in FIG. 4 in its assembled state), once assembled, the pliable heat sink 230 is in substantially direct contact with both the inside surface 241 of the outside casing 201 and/or the inside surface of the inside casing 202 and the metal core 220. This configuration reduces the heat transfer resistance between the casing 200 and the metal core 220 by increasing the thermal contact and therefore thermal conductivity between the casing 200 and the metal core 220.

FIG. 5 shows an exploded, perspective view of another embodiment 120A of the handle shown in FIG. 3. In this view, the inside casing 202 is removed from the outside casing 201 to show the outside surface 240 and the inside surface 241 of the outside casing 201. In this embodiment, a pliable heat sink in the nature of a thermally conductive pad 230A is preferably disposed on the inside surface 241 of the outside casing 201 proximal to the bottom 121 of the handle 120A. The advantage of locating the thermally conductive pad 230A proximal to the bottom 121 of the handle 120A is that it concentrates the heat distribution and storage properties of the thermally conductive pad 230A in the location that receives the most thermal energy from any heat source below the handle 120A.

FIG. 8 shows a schematic, cross sectional view of this embodiment in its assembled state. The pliable heat sink 230A is in direct contact with the inside surface 241 of the outside casing 201, allowing for efficient heat transfer between the outside surface 240/the casing 200 and the pliable heat sink 230A. The application of such pliable heat sink 230A to the inside surface 241 of the outside casing 201 pulls thermal energy away from the outside surface 240 without the use of the metal core 220. In one embodiment, it is possible to keep the surface temperature of the handle to 60 degrees Fahrenheit after 30 minutes of an exemplary heat source being active, well below the target temperature of 75 degrees Fahrenheit where it becomes uncomfortable for a user to touch, and well below the temperature of 72 degrees Fahrenheit at which current production handles are able to achieve under the same testing conditions.

As should be apparent to a person skilled in the art, a plurality of thermally conductive pads 230A can be disposed on the inside casing 201 throughout the entire length of the inside surface 241 in situations where, for example, a single thermally conductive pad 230A provides an insufficient thermal mass, or where thermal energy is delivered to the handle 120A throughout its entire length. This embodiment may be used, for example, where the handle is mounted substantially horizontally as opposed to substantially vertically.

In yet another embodiment of the handle 120, not shown, thermally conductive pads 230A are disposed on both the outside casing 201 and the inside casing 202 at either the bottom 121, or throughout the entire interior of the handle 120.

In these various embodiments of the handle 120 comprising a thermally conductive pad 230A, preferably, no metal core 220 is required because the thermal mass and higher thermal capacity of the thermally conductive pad 230A, in addition to its high thermal conductivity, is sufficient to draw thermal energy away from the outside surface 240. However, if additional thermal mass is required beyond that which the one or more thermally conductive pads 230A can provide, a metal core 220 may be inserted into the cavity defined by the outside casing 201 and the inside casing 202. In this instance, the one or more thermally conductive pads 230A would be in substantially direct contact with both the inside surface 241 and the metal core 220 to provide the most efficient heat transfer between the outside surface 240 the casing 200 and the metal core 220. The metal core 220 would provide additional thermal storage capacity which would allow the temperature of the outside surface 240 to be reduced even further, or for a longer period of time.

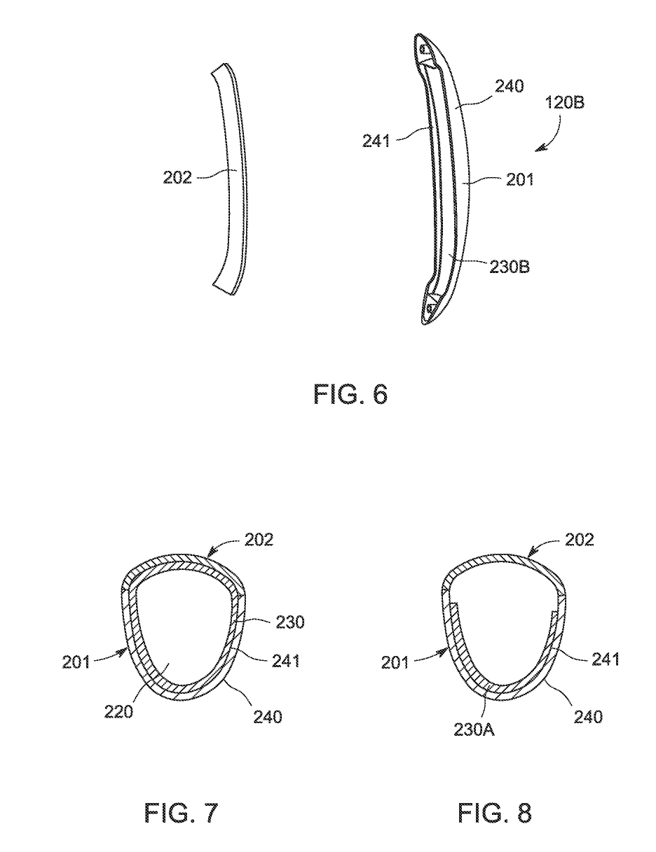

FIG. 6 shows an exploded, perspective view of another embodiment 120B of the handle. In this view, the inside casing 202 is removed from the outside casing 201 to show the outside surface 240 and the inside surface 241. In this embodiment, a pliable heat sink in the nature of a thermally conductive paste 230B is disposed on the inside surface 241 of the outside casing 201 throughout approximately the entire length of the handle 120. In another embodiment of the handle, not shown, the thermally conductive paste 230B is disposed on both the outside casing 201 and the inside casing 202 throughout approximately their entire length. In the embodiment shown in FIG. 6, the thermally conductive paste 230B is in substantially direct contact with the inside surface 241 of the outside casing 201, allowing for efficient heat transfer between the outside surface 240/the casing 200 and the thermally conductive paste 230B. The application of such thermally conductive paste 230B to the inside surface 241 of the outside casing 201 creates a surface capable of dissipating heat along the entire length of the handle without the use of a metal core 220. In this embodiment, no metal core 220 is used. In one embodiment, it is possible to keep the surface temperature of the handle to 60 degrees Fahrenheit after 30 minutes of an exemplary heat source being active, well below the target temperature of 75 degrees Fahrenheit where it becomes uncomfortable for a user to touch.

The embodiments described herein are not limited in practice with respect to appliances and microwave ovens installed above a range or a cook top. Rather, the exemplary embodiments can be implemented and utilized in connection with many other applications of handles in general. For example, cabinet doors, charcoal and/or gas grills, and pots and/or pans may use the handles disclosed herein to reduce the temperature of the exterior surface of the handle.

This written description uses examples to disclose the invention, including the best mode, and also to enable any person skilled in the art to practice the invention, including making and using any devices or systems and performing any incorporated methods. While various specific embodiments have been disclosed in the foregoing, those skilled in the art will recognize that the spirit and scope of the claims allows for equally effective modifications. Especially, mutually non-exclusive features of the embodiments described above may be combined with each other. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A handle comprising:
a casing comprising an outside surface and an inside surface; and
a pliable heat sink disposed on the inside surface of the casing.

2. The handle of claim 1, wherein the pliable heat sink has a thermal conductivity higher than a thermal conductivity of the casing.

3. The handle of claim 1, wherein the pliable heat sink comprises silver and a binding agent.

4. The handle of claim 1, wherein the pliable heat sink comprises a thermally conductive paste.

5. The handle of claim 4, further comprising a solid core disposed inside the casing, wherein the thermally conductive paste substantially fills a gap between the inside surface and the solid core.

6. The handle of claim 5, wherein the solid core has a thermal conductivity higher than a thermal conductivity of the casing.

7. The handle of claim 1, wherein the pliable heat sink comprises at least one thermally conductive pad.

8. The handle of claim 7, further comprising a solid core disposed inside the casing, wherein the at least one thermally conductive pad fills a gap between the inside surface and the solid core at a location of the at least one thermally conductive pad.

9. The handle of claim 8, wherein the solid core has a thermal conductivity higher than a thermal conductivity of the casing.

10. The handle of claim 7, wherein the at least one thermally conductive pad is disposed proximal to a lower portion of the handle.

11. A microwave oven comprising:
a door; and
a handle attached to the door, the handle comprising a casing comprising an outside surface and an inside surface, and a pliable heat sink disposed on the inside surface of the casing.

12. The microwave oven of claim 11, wherein the pliable heat sink has a thermal conductivity higher than a thermal conductivity of the casing.

13. The microwave oven of claim 11, wherein the pliable heat sink comprises silver and a binding agent.

14. The microwave oven of claim 11, wherein the handle further comprises a solid core disposed inside the casing, and wherein the pliable heat sink comprises a thermally conductive paste which substantially fills a gap between the inside surface of the casing and the solid core.

15. The microwave oven of claim 11, wherein the solid core has a thermal conductivity higher than a thermal conductivity of the casing.

16. The microwave oven of claim 11, wherein the pliable heat sink comprises at least one thermally conductive pad.

17. The microwave oven of claim 16, wherein the at least one thermally conductive pad is disposed proximal to a lower portion of the handle.
